(19) United States
(12) Patent Application Publication
(10) Pub. No.: US 2018/0224843 A1
(43) Pub. Date: Aug. 9, 2018

(54) MONITORING SYSTEM

(71) Applicant: TOYOTA JIDOSHA KABUSHIKI KAISHA, Toyota-shi (JP)

(72) Inventor: Makoto OISHI, Toyota-shi (JP)

(73) Assignee: TOYOTA JIDOSHA KABUSHIKI KAISHA, Toyota-shi (JP)

(21) Appl. No.: 15/873,046

(22) Filed: Jan. 17, 2018

(30) Foreign Application Priority Data
Jan. 18, 2017 (JP) 2017-006831

(51) Int. Cl. G05B 23/02; G05B 15/02

(52) U.S. Cl. CPC G05B 23/0286; G05B 2219/34475; G05B 15/02

(57) ABSTRACT

In a monitoring system for mutually monitoring first and second control devices, when the first and second control devices detect an abnormality in a counterpart control device respectively, the first and second control devices output, to a monitoring reset unit, a reset request signal that matches a reference reset request signal for the counterpart control device, and the monitoring reset unit resets the counterpart control device when the reset request signal for the counterpart control device from the first and second control devices matches the reference reset request signal.

### CROSS-REFERENCE TO RELATED APPLICATION

The present disclosure claims priority to Japanese Patent Application No. 2017-6831 filed on Jan. 18, 2017, which is incorporated herein by reference in its entirety including specification, drawings and claims.

### TECHNICAL FIELD

The present disclosure relates to a monitoring system, and more particularly, to a monitoring system for mutually monitoring first and second control devices.

### BACKGROUND

As a monitoring system of this type, a system for mutually monitoring a main microcomputer and a sub microcomputer has heretofore been proposed (e.g., see JP2014-102662A). In this monitoring system, the sub microcomputer receives a first pulse signal from the main microcomputer, calculates a frequency of the first pulse signal, and transmits a reset signal to the main microcomputer when the frequency deviates from a first normal frequency range, to thereby reset the main microcomputer. Further, the main microcomputer receives a second pulse signal from the sub microcomputer, calculates a frequency of the second pulse signal, and transmits a reset signal to the sub microcomputer when the frequency deviates from a second normal frequency range, to thereby reset the sub microcomputer.

### CITATION LIST

### Patent Literature

PTL1: JP2014-102662A

### SUMMARY

In the monitoring system described above, when one of the main microcomputer and the sub microcomputer is in an abnormal state, it is determined that the frequency of a pulse signal from the other one of the microcomputers deviates from a normal frequency range, regardless of whether or not the frequency of the pulse signal from the other one of the microcomputers falls within the normal frequency range, so that the other one of the microcomputers may be erroneously reset.

A principle object of a monitoring system according to the present disclosure is to prevent first and second control devices from being erroneously reset.

### Solution to Problem

In order to achieve the above object, the monitoring system of the disclosure is implemented by an aspect described below.

The present disclosure is directed to a monitoring system. The monitoring system for mutually monitoring first and second control devices, the monitoring system including a monitoring reset unit configured to monitor the first and second control devices and reset the first and second control devices. When the first and second control devices detect an abnormality in a counterpart control device, the first and second control devices output, to the monitoring reset unit, a reset request signal that matches a reference reset request signal for the counterpart control device, respectively, and the monitoring reset unit resets the counterpart control device when the reset request signal for the counterpart control device from the first and second control devices matches the reference reset request signal.

In the monitoring system according to the present disclosure, when the first and second control devices detect an abnormality in the counterpart control device, the first and second control devices output, to the monitoring reset unit, the reset request signal that matches the reference reset request signal for the counterpart control device. When the reset request signal for the counterpart control device from the first and second control devices matches the reference reset request signal, the monitoring reset unit resets the counterpart control device. With this configuration, it is considered that, when one of the first and second control devices is in the abnormal state, the reset request signal from the counterpart (the other) control device that is output from the one of the control devices to the monitoring reset unit does not match the reference reset request signal. Thus, when one of the control devices is in the abnormal state, the counterpart control device can be prevented from being erroneously reset due to the abnormality.

### BRIEF DESCRIPTION OF DRAWINGS

FIG. 1 is a block diagram schematically illustrating a configuration of a monitoring system 20 as an embodiment of the present disclosure;

FIG. 2 is a flowchart illustrating an example of a second microcomputer processing routine;

FIG. 3 is a flowchart illustrating an example of a monitoring microcomputer processing routine;

FIG. 4 is an explanatory diagram illustrating a reference first reset request signal;

FIGS. 5A to 5C are explanatory diagrams each illustrating an example of a first reset request signal;

FIG. 6 is a block diagram schematically illustrating a configuration of a monitoring system 120 according to a modified example;

FIG. 7 is a block diagram schematically illustrating a configuration of a monitoring system 220 according to another modified example;

FIG. 8 is a block diagram schematically illustrating a configuration of a monitoring system 320 according to still another modified example;

FIG. 9 is an explanatory diagram illustrating an example of an operation of the monitoring system 220 when a first microcomputer monitoring unit 42 of a second microcomputer 40 detects that a first microcomputer 30 is in an abnormal state; and

FIG. 10 is an explanatory diagram illustrating an example of an operation of the monitoring system 320 when the first microcomputer monitoring unit 42 of the second microcomputer 40 detects that the first microcomputer 30 is in the abnormal state.

### DESCRIPTION OF EMBODIMENTS

The following describes aspects of the disclosure with reference to some embodiments.

### Embodiments

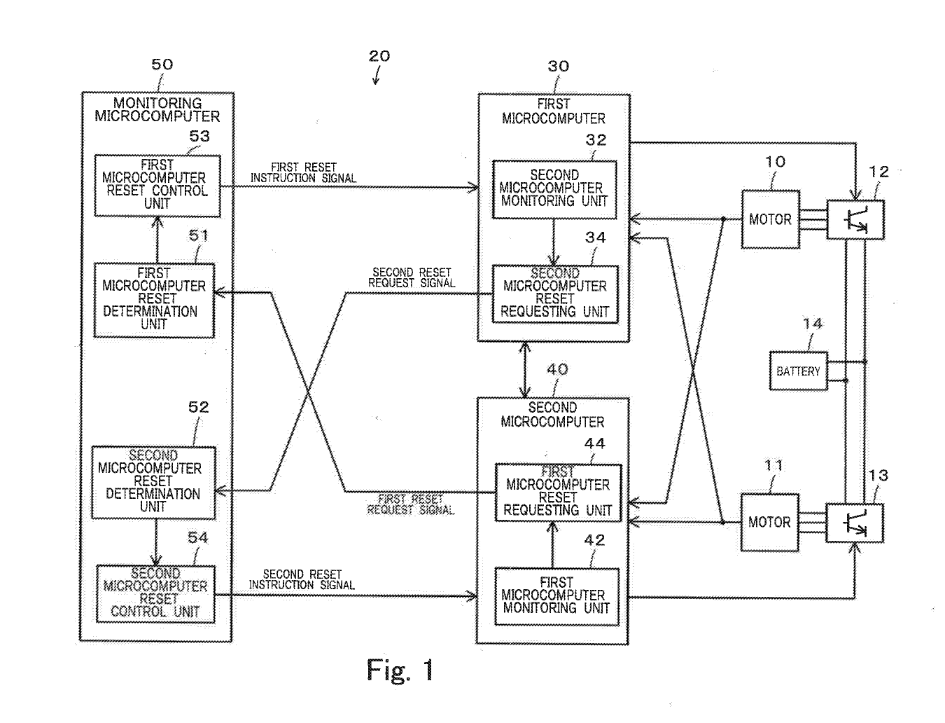

FIG. 1 is a block diagram schematically illustrating a configuration of a monitoring system 20 as an embodiment of the present disclosure. As illustrated in FIG. 1, the monitoring system 20 is configured as a monitoring system for mutually monitoring first and second microcomputers (hereinafter referred to as “microcomputers”) 30 and 40 as first and second control devices, respectively, for driving and controlling first and second motors 10 and 11, respectively, and includes a monitoring microcomputer 50 as a monitoring reset unit, as well as the first and second microcomputers 30 and 40. The monitoring system 20 is mounted on an electric vehicle or a hybrid vehicle including the first and second motors 10 and 11, first and second inverters 12 and 13 for driving the first and second motors 10 and 11, respectively, and a battery 14 that exchanges power with the first and second motors 10 and 11 through the first and second inverters 12 and 13, respectively. The first and second motors 10 and 11 are each configured as a synchronous generator-motor. A monitoring IC may be used instead of the monitoring microcomputer 50.

The first and second microcomputers 30 and 40 and the monitoring microcomputer 50 are configured as a CPU-based microprocessor and include a ROM configured to store processing programs, a RAM configured to temporarily store data, input/output ports and a communication port, respectively, in addition to the CPU, although not being illustrated. The first and second microcomputers 30 and 40 and the monitoring microcomputer 50 are connected via the respective communication ports.

The first and second microcomputers 30 and 40 receive rotational positions θm1 and θm2 from a rotational position detection sensor for detecting a rotational position of a rotor of each of the first and second motors 10 and 11, phase currents Iu1, Iv1, Iu2, and Iv2 from a current sensor for detecting a current flowing through each phase of the first and second motors 10 and 11, and the like through an input port. The first and second microcomputer 30 and 40 output a switching control signal and the like to a plurality of switching elements of the first and second inverters 12 and 14 through an output port.

The first and second microcomputers 30 and 40 include, as functional blocks, second and first microcomputer monitoring units 32 and 42 and second and first microcomputer reset requesting units 34 and 44, respectively. In this case, the second and first microcomputer monitoring units 32 and 42 monitor the second and first microcomputers 40 and 30 (determine whether the second and first microcomputers are in a normal state or in an abnormal state). The second and first microcomputer reset requesting units 34 and 44 output, to the monitoring microcomputer 50, second and first reset request signals (reset request signals for the second and first microcomputers 40 and 30), respectively, based on monitoring results (determination results) of the second and first microcomputers 40 and 30 by the second and first microcomputer monitoring units 32 and 42. The second and first reset request signals are voltage signals each having a logical level of a Lo level or a Hi level.

The monitoring microcomputer 50 includes, as functional blocks, first and second microcomputer reset determination units 51 and 52 and first and second microcomputer reset control units 53 and 54. In this case, the first and second microcomputer reset determination units 51 and 52 determine whether or not the first and second microcomputers 30 and 40 are reset based on first and second reset request signals from the first and second microcomputer reset requesting units 44 and 34, respectively. The first and second microcomputer reset control units 53 and 54 output, to the first and second microcomputers 30 and 40, respectively, first and second reset instruction signals (reset instruction signals for the first and second microcomputers 30 and 40) based on the determination results obtained by the first and second microcomputer reset determination units 51 and 52. The first and second reset instruction signals are voltage signals each having a logical level of the Hi level or the Lo level. When the first and second reset instruction signals are at the Lo level, the first and second microcomputers 30 and 40 are reset (restarted).

In the monitoring system 20 according to the embodiment having the configuration described above, when the first and second microcomputers 30 and 40 control switching of the plurality of switching elements of the first and second inverters 12 and 13 to drive and control the first and second motors 10 and 11, the first and second microcomputers 30 and 40 execute the following processes (A1) to (A7):

(A1) a process of acquiring the rotational positions θm1 and θm2 of the rotors of the first and second motors 10 and 11, and the phase currents Iu1, Iv1, Iu2, and Iv2 of the respective phases;

(A2) a process of converting the rotational positions θm1 and θm2 of the rotors of the first and second motors 10 and 11 into electrical angles θe1 and θe2;

(A3) a process of performing a coordinate conversion (three-phase to two-phase conversion) of the phase currents Iu1, Iv1, Iu2, and Iv2 of the respective phases of the first and second motors 10 and 11 into d-axis and q-axis currents Id1, Iq1, Id2, and Iq2 by using the electrical angles θe1, θe2 of the first and second motors 10 and 11;

(A4) a process of setting d-axis and q-axis current commands Id1*, Iq1*, Id2*, and Iq2* based on torque commands Tm1* and Tm2* of the first and second motors 10 and 11;

(A5) A process of setting d-axis and q-axis voltage commands Vd1*, Vq1*, Vd2*, and Vq2* by using the d-axis and q-axis currents Id1, Iq1, Id2, and Iq2 and the current commands Id1*, Iq1*, Id2*, and Iq2*;

(A6) A process of performing a coordinate conversion (two-phase to three-phase conversion) of the d-axis and q-axis voltage commands Vd1*, Vq1*, Vd2*, and Vq2* into voltage commands Vu1*, Vv1*, Vw1*, Vu2*, Vv2*, and Vw2* of the respective phases; and

(A7) A process of generating PWM signals for the first and second inverters 12 and 13 by using the voltage commands Vu1*, Vv1*, Vw1*, Vu2*, Vv2*, and Vw2* of the respective phases, and outputting the generated PWM signals to the first and second inverters 12 and 13.

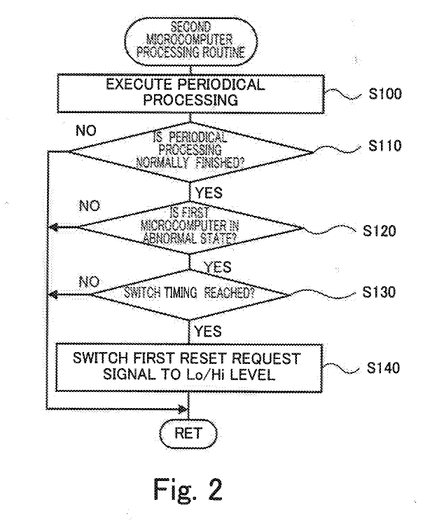

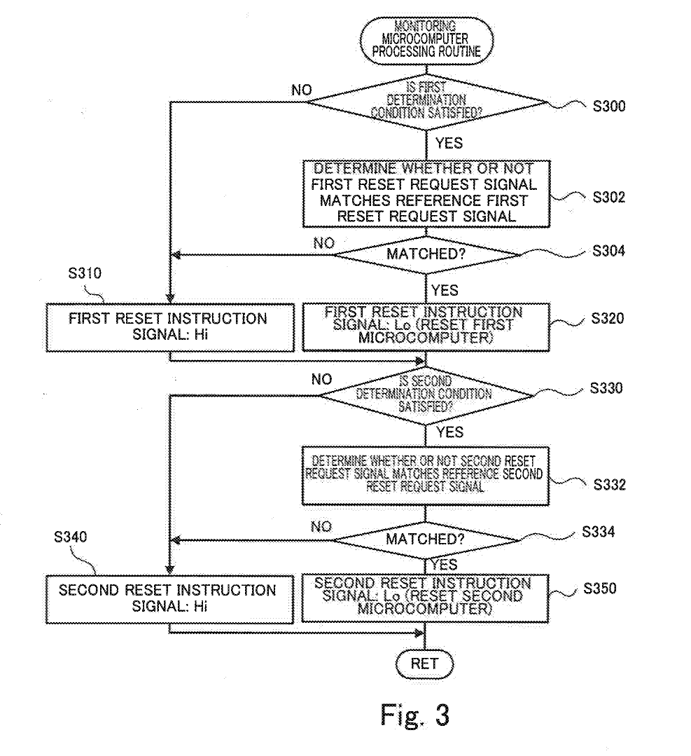

Next, the operation of the monitoring system 20 according to the embodiment having the configuration described above will be described. The first and second microcomputers 30 and 40 execute first and second microcomputer processing routines, respectively, and the monitoring microcomputer 50 executes a monitoring microcomputer processing routine. These routines are repeatedly executed. FIG. 2 illustrates an example of the second microcomputer processing routine, and FIG. 3 illustrates an example of the monitoring microcomputer processing routine. These routines are sequentially described below. It can be considered that the first microcomputer processing routine is similar to the second microcomputer processing routine.

When the second microcomputer processing routine illustrated in FIG. 2 is executed, the second microcomputer 40 executes periodical processing (step S100). Examples of the periodical processing executed by the second microcomputer 40 include a communication process between the first microcomputer 30 and the second microcomputer 40, as well as the above-described processes (A1) to (A7).

Next, it is determined whether or not the periodical processing is normally finished (step S110). When it is determined that the periodical processing is not normally finished, the first microcomputer reset requesting unit 44 terminates this routine without switching the Lo/Hi level of the first reset request signal (reset request signal for the first microcomputer 30) (the first reset request signal is held without being inverted).

In step S110, when it is determined that the periodical processing is normally finished, the first microcomputer monitoring unit 42 determines whether the first microcomputer 30 is in the normal state or in the abnormal state (step S120). The process of step S120 can be performed by, for example, acquiring the electrical angle θe1 of the first motor 10, the phase currents Iu1 and Iv1 of the respective phases, and the torque command Tm1* from each sensor and the first microcomputer 30, estimating the output torque Tm1 of the first motor 10 based on the electrical angle θe1 and the phase currents Iu1 and Iv1, and comparing the torque command Tm1* with the output torque Tm1 to determine whether or not the first motor 10 is normally driven and controlled. When the first microcomputer monitoring unit 42 determines that the first microcomputer 30 is in the normal state, the first microcomputer reset requesting unit 44 terminates this routine without switching the Lo/Hi level of the first reset request signal.

In step S120, when the first microcomputer monitoring unit 42 determines that the first microcomputer 30 is in the abnormal state, the first microcomputer reset requesting unit 44 determines whether or not a switch timing for switching the Lo/Hi level of the first reset request signal is reached (step S130). In this case, the switch timing is determined in such a manner that the first reset request signal matches a reference first reset request signal described later.

In step S130, when it is determined that the switch timing is not reached, the first microcomputer reset requesting unit 44 terminates this routine without switching the Lo/Hi level of the first reset request signal. On the other hand, when it is determined that the switch timing is reached, the first microcomputer reset requesting unit 44 switches the Lo/Hi level of the first reset request signal (step S140), and terminates this routine.

Accordingly, in the second microcomputer 40, when the first microcomputer monitoring unit 42 determines (detects) that the first microcomputer 30 is in the abnormal state, the first microcomputer reset requesting unit 44 switches the Lo/Hi level of the first reset request signal at the above-mentioned switch timing, thereby setting the first reset request signal as the signal that matches the reference first reset request signal. Similarly, in the first microcomputer 30, when the second microcomputer monitoring unit 32 determines (detects) that the second microcomputer 40 is in the abnormal state, the second reset request signal is set as the signal that matches the reference second reset request signal.

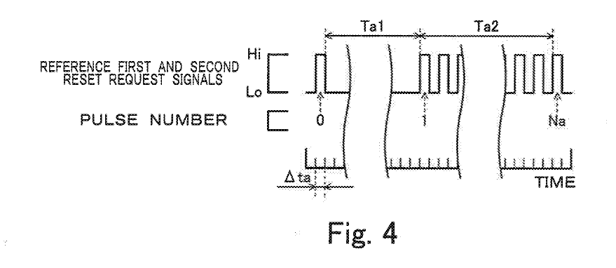

The reference first and second reset request signals will now be described. The reference first reset request signal is stored in ROMs, which are not illustrated, of the first microcomputer 30 and the monitoring microcomputer 50, and the reference second reset request signal is stored in ROMs, which are not illustrated, of the second microcomputer 40 and the monitoring microcomputer 50. In the embodiment, the reference first and second reset request signals (which are the same signal) illustrated in FIG. 4 are used as the reference first and second reset request signals, respectively. In FIG. 4, a predetermined period Δta (a scale interval of a horizontal axis) is a time (the same time) required for executing the periodical processing by the first and second microcomputers 30 and 40. The predetermined period Δta is, for example, 2 msec, 2.5 msec, or 3 msec. In this case, examples of the periodical processing executed by the first microcomputer 30 include a communication process between the first microcomputer 30 and the second microcomputer 40, as well as the above-described processes (A1) to (A7), like the periodical processing executed by the second microcomputer 40. The time required for executing the periodical processing by the first microcomputer 30 may be different from the time required for executing the periodical processing by the second microcomputer 40, and the reference first and second reset request signals may be different from each other.

As illustrated in FIG. 4, each of the reference first and second reset request signals is a signal having a predetermined pulse train, specifically, a signal having a pulse train including one pulse having a pulse number 0, a predetermined period Ta1, and Na number of pulses of pulse numbers 1 to Na (Na≥2) in this order. The pulses of the pulse numbers 0 to Na are generated by switching the signal from the Lo level to the Hi level (rising edge) and switching the signal from the Hi level to the Lo level (falling edge). The time of each of the pulses of the pulse numbers 0 to Na (time when the signal is at the Hi level) and each cycle (an interval of a rising edge) of two continuous pulses of the pulse numbers 1 to Na are twice as long as the predetermined period Δta. The predetermined period Ta1 is an interval between the pulse of the pulse number 0 and the pulse of the pulse number 1. For example, 15 times, 18 times, or 21 times as long as the predetermined period Δta can be used. As the value Na, for example, 7, 10, or 13 can be used. A predetermined period Ta2 illustrated in FIG. 4 is a time from a rising edge of the pulse of the pulse number 1 to a rising edge of the pulse of the pulse number Na, and is represented by “Δta×(Na−1)×2”.

Next, the monitoring microcomputer processing routine illustrated in FIG. 3 will be described. When this routine is executed, in the monitoring microcomputer 50, the first microcomputer reset determination unit 51 determines whether or not a first determination condition is satisfied (step S300). In this case, the first determination condition is a condition for determining whether or not the first reset request signal from the first microcomputer reset requesting unit 44 of the second microcomputer 40 matches the reference first reset request signal. When it is determined that the first determination condition is satisfied, it is determined whether or not the first reset request signal matches the reference first reset request signal (steps S302 and S304).

The determination as to whether or not the first determination condition is satisfied can be made by, for example, determining whether or not the following conditions (B1) and (B2) are satisfied for the first reset request signal.

(B1) A condition in which a time (Δta+Ta1+Ta2) from a rising edge of the pulse of the pulse number 0 has elapsed

(B2) A condition in which pulses are continuously generated (the interval between a rising edge of the latest pulse and a rising edge of the pulse immediately before the latest pulse is twice as long as the predetermined period Δta)

The determination as to whether or not the first reset request signal matches the reference first reset request signal is made by, for example, determining whether or not the following conditions (C1) and (C2) are satisfied for the first reset request signal.

(C1) A condition in which the interval between a rising edge of the pulse of the pulse number 0 and a rising edge of the pulse of the pulse number 1 is equal to the time (Δta+Ta1)

(C2) A condition in which a timing when the time (Δta+Ta1+Ta2) from a rising edge of the pulse of the pulse number 0 has elapsed is equal to a timing of a rising edge of the pulse of the pulse number Na

In step S300, when it is determined that the first determination condition is not satisfied, and when it is determined in step S300 that the first determination condition is satisfied and it is determined in steps S302 and S304 that the first reset request signal does not match the reference first reset request signal, the first microcomputer reset control unit 53 sets the first reset instruction signal (reset instruction signal for the first microcomputer 30) to the Hi level (step S310). When it is determined in steps S302 and S304 that the first reset request signal does not match the reference first reset request signal, the pulse number may be reset, for example, when the above-mentioned condition (B2) is not satisfied, in case the first microcomputer monitoring unit 42 thereafter detects an abnormality in the first microcomputer 30.

When it is determined in step S300 that the first determination condition is satisfied, and when it is determined in steps S302 and S304 that the first reset request signal matches the reference first reset request signal, the first microcomputer reset control unit 53 sets the first reset instruction signal to the Lo level (step S320).

Thus, when the first reset instruction signal is switched from the Hi level to the Lo level, the first microcomputer 30 starts resetting (starts to restart). Further, the first microcomputer 30 continues resetting for a period in which the first reset instruction signal is held at the Lo level, and then the first microcomputer 30 is restored (restart is completed) when the first reset instruction signal is switched from the Lo level to the Hi level. The first reset instruction signal is switched from the Lo level to the Hi level, for example, when the above-mentioned condition (B2) is not satisfied and it is determined in step S300 that the first determination condition is not satisfied.

Next, the second microcomputer reset determination unit 52 determines whether or not the second determination condition is satisfied (step S330). In this case, the second determination condition is a condition for determining whether or not the second reset request signal from the second microcomputer reset requesting unit 34 of the first microcomputer 30 matches the reference second reset request signal. Further, when it is determined that the second determination condition is satisfied, it is determined whether or not the second reset request signal matches the reference second reset request signal (steps S332 and S334). The determination process of steps S330 to S334 can be performed in a manner similar to the determination process of steps S300 to S304.

When it is determined in step S330 that the second determination condition is not satisfied, or when it is determined in step S330 that the second determination condition is satisfied and it is determined in steps S332 and S334 that the second reset request signal does not match the reference second reset request signal, the second microcomputer reset control unit 54 sets the second reset instruction signal to the Hi level (step S340), and terminates this routine.

When it is determined in step S330 that the second determination condition is satisfied and it is determined in steps S332 and S334 that the second reset request signal matches the reference second reset request signal, the second microcomputer reset control unit 54 sets the second reset instruction signal to the Lo level (step S350), and terminates the routine.

In this manner, when the second reset instruction signal is switched from the Hi level to the Lo level, the second microcomputer 40 starts resetting (starts to restart). Further, the second microcomputer 40 continuously performs resetting for a period in which the second reset instruction signal is held at the Lo level, and then the second microcomputer 40 is restored (restart is completed) when the second reset instruction signal is switched from the Lo level to the Hi level.

In the embodiment, when the second microcomputer 40 is in the abnormal state, it is considered that the first reset request signal output from the second microcomputer 40 to the monitoring microcomputer 50 does not match the reference first reset request signal. Thus, when the second microcomputer 40 is in the abnormal state, the first microcomputer 30 can be prevented from being erroneously reset due to the abnormal state. In addition, a signal having a predetermined pulse train is used as the reference first reset request signal, and a signal having a pulse train including one pulse, the predetermined period Ta1, and Na number of pulses in this order is used as the signal having the predetermined pulse train, thereby preventing the first reset request signal from matching the reference first reset request signal when the second microcomputer 40 is in the abnormal state. Note that when the second microcomputer 40 is in the abnormal state and the abnormal state of the second microcomputer 40 is detected by the second microcomputer monitoring unit 32 of the first microcomputer 30, the second microcomputer reset requesting unit 34 outputs the second reset request signal that matches the reference second reset request signal. Further, when the second microcomputer reset determination unit 52 of the monitoring microcomputer 50 determines that the second reset request signal matches the reference second reset request signal, the second microcomputer reset control unit 54 sets the second reset instruction signal to the Lo level. As a result, the second microcomputer 40 is reset. The same holds true when the first microcomputer 30 is in the abnormal state.

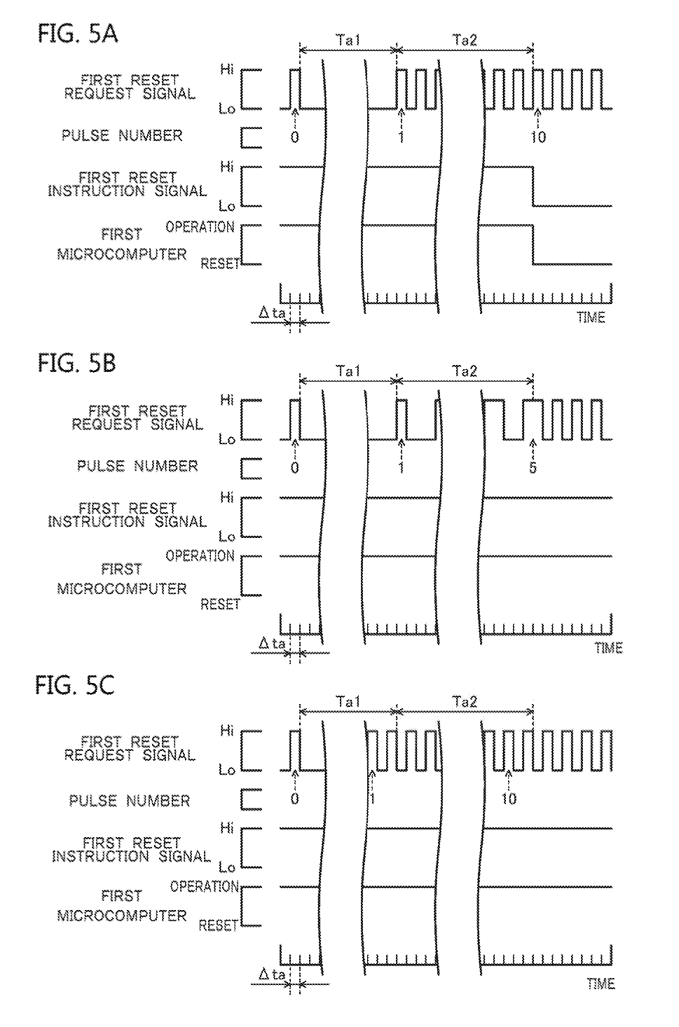

FIGS. 5A to 5C are explanatory diagrams each illustrating an example of the first reset request signal. In examples illustrated in FIGS. 5A to 5C, the value Na of 10 is used to determine whether or not the first determination condition is satisfied, by using the above-mentioned conditions (B1) and (B2), and it is determined whether or not the first reset request signal matches the reference first reset request signal, by using the above-mentioned conditions (C1) and (C2). When the conditions (B1) and (B2) are satisfied, in the case of FIG. 5A, the conditions (C1) and (C2) are satisfied. Accordingly, it is determined that the first reset request signal matches the reference first reset request signal and the first reset instruction signal is set to the Lo level. As a result, the first microcomputer 30 is reset. In the case of FIG. 5B, the condition (C1) is satisfied, but the condition (C2) is not satisfied. Accordingly, it is determined that the first reset request signal does not match the reference first reset request signal, and the first reset instruction signal is held at the Hi signal. Thus, the first microcomputer 30 is not reset. In the case of FIG. 5C, the conditions (C1) and (C2) are not satisfied. Accordingly, it is determined that the first reset request signal does not match the reference first reset request signal, and the first reset instruction signal is held at the Hi signal. Thus, the first microcomputer 30 is not reset.

In the monitoring system 20 according to the embodiment described above, in the first and second microcomputers 30 and 40, when the second and first microcomputer monitoring units 32 and 42 determine (detect) the abnormal states of the second and first microcomputers 40 and 30, the second and first reset request signals that match the reference second and first reset request signals, respectively, are output to the monitoring microcomputer 50 from the second and first microcomputer reset requesting units 34 and 44. In the monitoring microcomputer 50, the first and second microcomputer reset determination units 51 and 52 determine whether or not the second and first reset request signals from the second and first microcomputer reset requesting units 34 and 44 match the reference second and first reset request signals, respectively, and when the second and first reset request signals match the reference second and first reset request signals, respectively, the first and second microcomputers 30 and 40 are reset. With this configuration, for example, when the second microcomputer 40 is in the abnormal state, it is considered that the first reset request signal output from the second microcomputer 40 to the monitoring microcomputer 50 does not match the reference first reset request signal. Thus, when the second microcomputer 40 is in the abnormal state, the first microcomputer 30 can be prevented from being erroneously reset due to the abnormality. The same holds true when the first microcomputer 30 is in the abnormal state. Specifically, when one of the first and second microcomputers 30 and 40 is in the abnormal state, the counterpart control device can be prevented from being erroneously reset due to the abnormality.

In addition, signals having a predetermined pulse train are used as the reference first and second reset request signals. Further, a signal having a pulse train including one pulse, the predetermined period Ta1, and Na number of pulses in this order is used as the signal having the predetermined pulse train. With this configuration, when the second microcomputer 40 is in the abnormal state, the first reset request signal can be prevented from matching the reference first reset request signal. The same holds true when the first microcomputer 30 is in the abnormal state.

In the monitoring system 20 according to the embodiment, signals having a predetermined pulse train, specifically, signals having a pulse train including one pulse, the predetermined period Ta1, and Na (Na≥2) number of pulses in this order are used as the reference first and second reset request signals. However, the number of pulses prior to the predetermined period Ta1 is not limited to one, but instead may be two or more; the number of pulses after the predetermined period Ta1 is not limited to Na, but instead may be one; the predetermined period Ta1 may be omitted; and the time of each pulse, or each cycle of two continuous pulses may vary depending on the number of pulses.

In the monitoring system 20 according to the embodiment, signals having a predetermined pulse train is used as the reference first and second reset request signals. However, signals other than the signals having the predetermined pulse train may be used as the reference first and second reset request signals, as long as it can be determined whether or not the first and second reset request signals match the reference first and second reset request signals.

In the monitoring system 20 according to the embodiment, when the first determination condition is not satisfied, or when the first determination condition is satisfied and the first reset request signal does not match the reference first reset request signal, the monitoring microcomputer 50 sets the first reset instruction signal to the Hi level, and when the first determination condition is satisfied and the first reset request signal matches the reference first reset request signal, the monitoring microcomputer 50 sets the first reset instruction signal to the Lo level (the first microcomputer 30 is reset). Specifically, when the first determination condition is not satisfied after the first reset instruction signal is switched from the Hi level to the Lo level, the first reset instruction signal is immediately switched to the Hi level. However, when the first reset instruction signal is switched from the Hi level to the Lo level, the first reset instruction signal may be held at the Hi level until a predetermined period has passed, regardless of whether the first determination condition is not satisfied. Thus, the first reset instruction signal can be prevented from being switched frequently.

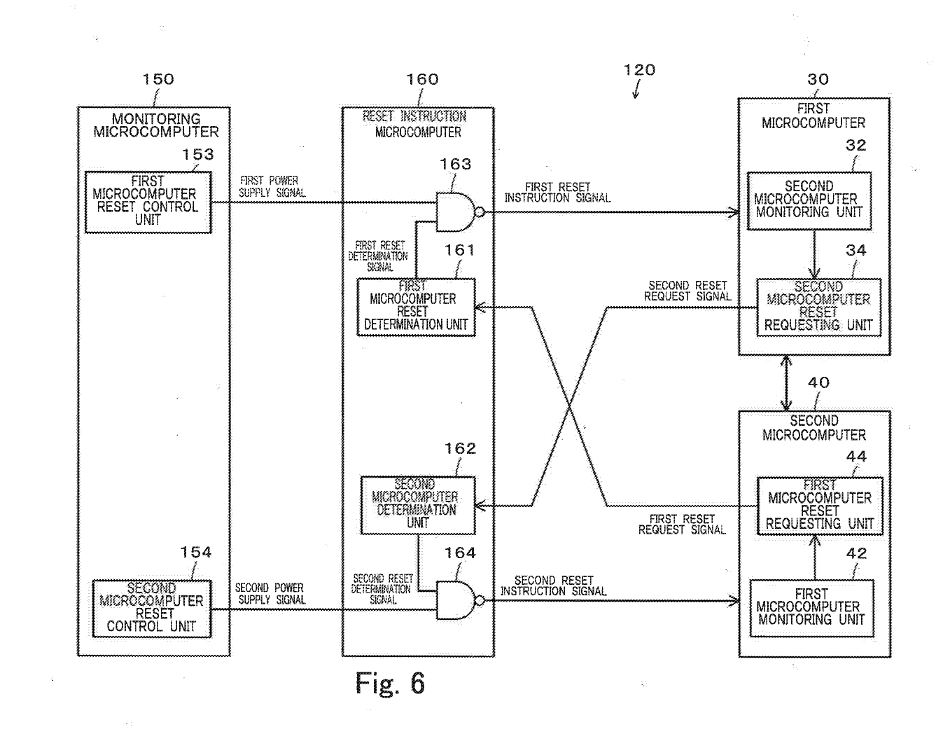

As illustrated in FIG. 1, the monitoring system 20 according to the embodiment includes the monitoring microcomputer 50 as well as the first and second microcomputers 30 and 40. However, monitoring systems 120, 220, and 320 according to modified examples illustrated in FIGS. 6, 7, and 8, respectively, may be employed. The monitoring systems 120, 220, and 320 will be described below in this order.

The monitoring system 120 illustrated in FIG. 6 will be described. As illustrated in FIG. 6, the monitoring system 120 includes a monitoring microcomputer 150 and a reset instruction microcomputer 160, in addition to the first and second microcomputers 30 and 40.

The monitoring microcomputer 150 includes first and second microcomputer reset control units 153 and 154 as functional blocks. When power is supplied from a power supply, which is not illustrated, to the monitoring microcomputer 150, the first and second microcomputer reset control units 153 and 154 set first and second power supply signals to be output to NAND circuits 163 and 164 of the reset instruction microcomputer 160 to the Hi level, respectively. When no power is supplied to the monitoring microcomputer 150, the first and second power supply signals are set to the Lo level.

The reset instruction microcomputer 160 includes, as functional blocks, first and second microcomputer reset determination units 161 and 162 and NAND circuits 163 and 164.

Like the first and second microcomputer reset determination units 51 and 52 of the monitoring microcomputer 50 in the monitoring system 20, the first and second microcomputer reset determination units 161 and 162 determine whether or not the first and second reset request signals from the first and second microcomputer reset requesting units 44 and 34 of the second and first microcomputers 40 and 30 match the reference first and second reset request signals, respectively. When it is determined that the first and second reset request signals do not match the reference first and second reset request signals, respectively, first and second reset determination signals (reset determination signals for the first and second microcomputers 30 and 40) to be output to the NAND circuits 163 and 164, respectively, are set to the Lo level. When it is determined that the first and second reset request signals match the reference first and second reset request signals, respectively, the first and second reset determination signals are set to the Hi level.

When the first and second power supply signals from the first and second microcomputer reset control units 153 and 154 and the first and second reset determination signals from the first and second microcomputer reset determination units 161 and 162 are at the Hi level, the NAND circuits 163 and 164 set the first and second reset instruction signals output to the first and second microcomputers 30 and 40, respectively, to the Lo level. In the other cases, the first and second reset instruction signals are set to the Hi level. When the first and second reset instruction signals are at the Lo level, the first and second microcomputers 30 and 40 are reset.

Like in the configuration of the monitoring system 20 according to the embodiment, also in the configuration of the monitoring system 120 as described above, when one of the first and second microcomputers 30 and 40 is in the abnormal state, the counterpart control device can be prevented from being erroneously reset due to the abnormality.

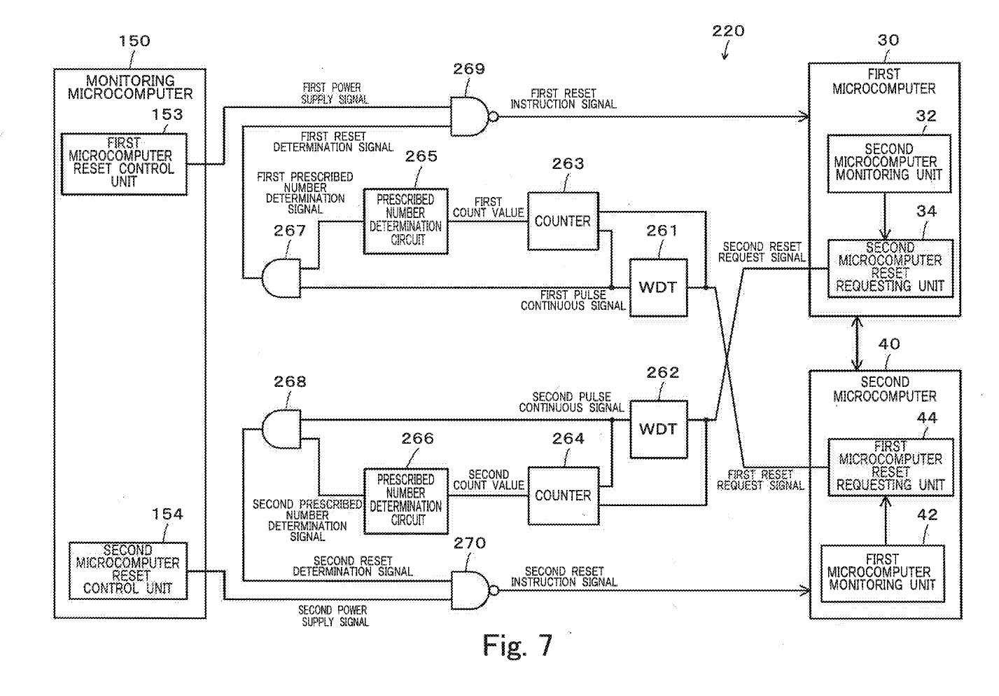

Next, the monitoring system 220 illustrated in FIG. 7 will be described. As illustrated in FIG. 7, the monitoring system 220 includes the above-mentioned monitoring microcomputer 150, watchdog timers (WDTs) 261 and 262, counters 263 and 264, prescribed number determination circuits 265 and 266, AND circuits 267 and 268, and NAND circuits 269 and 270, in addition to the first and second microcomputers 30 and 40.

The watchdog timers 261 and 262 monitor the pulse cycle of the first and second reset request signals from the first and second microcomputer reset requesting units 44 and 34. Further, first and second pulse continuous signals to be output to the counters 263 and 264 and the AND circuits 267 and 268 are switched from the Lo level to the Hi level when the pulse cycle of the first and second reset request signals (an interval between the latest pulse and the pulse immediately before the latest pulse) is equal to the time (Δta+Ta1) (see FIG. 4). After that, when the pulse cycle is equal to a predetermined period Δta (see FIG. 4), the signal is held at the Hi level, and when the pulse cycle is not equal to the predetermined period Δta, the signal is switched to the Lo level.

When the first and second pulse continuous signals from the watchdog timers 261 and 262 are at the Lo level, the counters 263 and 264 hold the first and second count values at the value 0, respectively. When the first and second pulse continuous signals are at the Hi level, the number of pulses of the first and second reset request signals is counted as the first and second count values, and the first and second count values are output to the prescribed number determination circuits 265 and 266, respectively.

The prescribed number determination circuits 265 and 266 determine whether or not the first and second count values from the counters 263 and 264 have reached first and second prescribed numbers, respectively. When the first and second count values are less than the first and second prescribed numbers, respectively, first and second prescribed number determination signals to be output to the AND circuits 267 and 268 are set to the Lo level. When the first and second count values are equal to or greater than the first and second prescribed number, respectively, the first and second prescribed number determination signals are set to the Hi level.

When the first and second pulse continuous signals from the watchdog timers 261 and 262 and the first and second prescribed number determination signals from the prescribed number determination circuits 265 and 266 are at the Hi level, the AND circuits 267 and 268 set the first and second reset determination signals to be output to the NAND circuits 269 and 270 to the Hi level. In the other cases, the first and second reset determination signals are set to the Lo level. Switching the first and second reset determination signals from the Lo level to the Hi level means that the first and second reset request signals match (are considered to match) the reference first and second reset request signals, respectively.

When the first and second power supply signals from the first and second microcomputer reset control units 153 and 154 and the first and second reset determination signals from the AND circuits 267 and 268 are at the Hi level, the NAND circuits 269 and 270 set the first and second reset instruction signals to be output to the first and second microcomputers 30 and 40 to the Lo level. In the other cases, the first and second reset instruction signals are set to the Hi level. When the first and second reset instruction signals are at the Lo level, the first and second microcomputers 30 and 40 are reset, respectively.

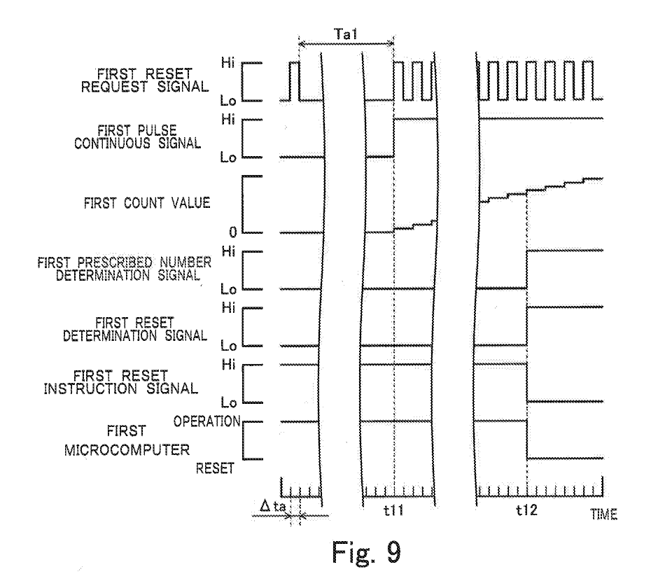

FIG. 9 is an explanatory diagram illustrating an example of an operation of the monitoring system 220 when a first microcomputer monitoring unit 42 of a second microcomputer 40 detects that a first microcomputer 30 is in an abnormal state. When the first microcomputer monitoring unit 42 of the second microcomputer 40 detects the abnormal state of the first microcomputer 30, the first microcomputer reset requesting unit 44 starts to output the first reset request signal that matches the reference first reset request signal. When determining that the pulse cycle of the first reset request signal is equal to the predetermined period Ta1 (time t11), the watchdog timer 261 switches the first pulse continuous signal from the Lo level to the Hi level. Accordingly, the counter 263 starts to count the number of pulses of the first reset request signal as the first count value. After that, when determining that the pulse cycle of the first reset request signal is equal to the predetermined period Δta, the watchdog timer 261 holds the first pulse continuous signal at the Hi level. Further, when the first count value reaches the first prescribed number or greater (time t12), the prescribed number determination circuit 265 switches the first prescribed number determination signal from the Lo level to the Hi level. As a result, the first pulse continuous signal and the first prescribed number determination signal are set to the Hi level; the first reset determination signal from the AND circuit 267 is switched from the Lo level to the Hi level; and the first reset instruction signal from the NAND circuit 269 is switched to the Lo level, so that the first microcomputer 30 is reset.

Like in the configuration of the monitoring system 20 according to the embodiment, also in the configuration of the monitoring system 220 as described above, when one of the first and second microcomputers 30 and 40 is in the abnormal state, the counterpart control device can be prevented from being erroneously reset due to the abnormality. The watchdog timers 261 and 262, the counters 263 and 264, the prescribed number determination circuits 265 and 266, the AND circuits 267 and 268, and the NAND circuits 269 and 270 may be implemented by hardware using a general-purpose IC, or similar functions may be implemented by software using a microcomputer or the like.

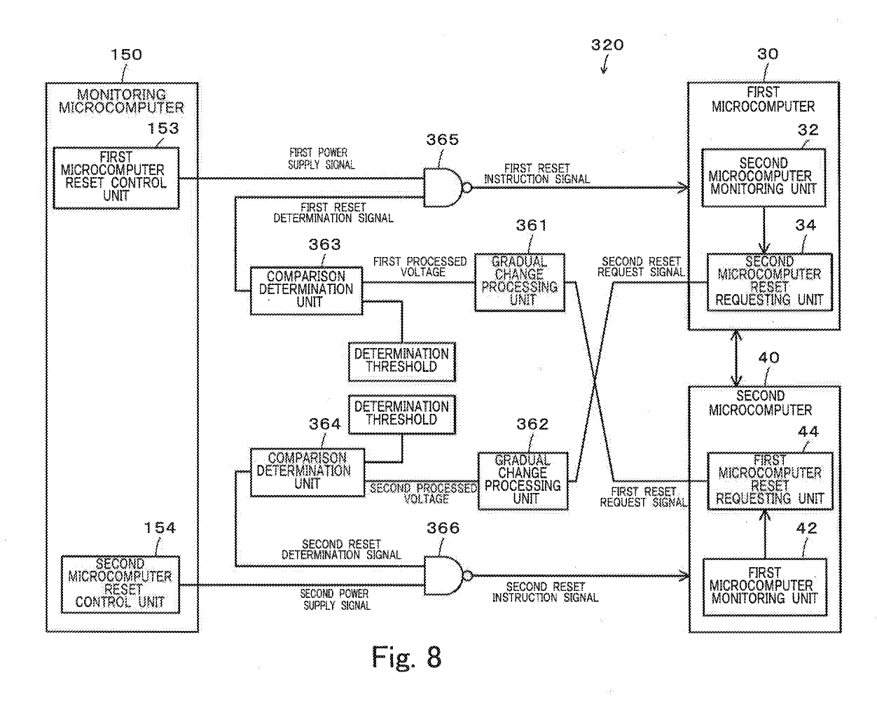

Next, the monitoring system 320 illustrated in FIG. 8 will be described. As illustrated in FIG. 8, the monitoring system 320 includes the above-mentioned monitoring microcomputer 150, gradual change processing units 361 and 362, comparison determination units 363 and 364, and NAND circuits 365 and 366, in addition to the first and second microcomputers 30 and 40.

The gradual change processing units 361 and 362 perform gradual change processing (annealing processing or rate processing) on the first and second reset request signals (voltage of Lo/Hi level) from the first and second microcomputer reset requesting units 44 and 34 of the second and first microcomputers 40 and 30 to generate first and second processed voltages, and outputs the first and second processed voltages to the comparison determination units 363 and 364, respectively.

The comparison determination units 363 and 364 determine whether or not the first and second processed voltages from the gradual change processing units 361 and 362, respectively, are within the range of first and second upper/lower limit determination thresholds. When the first and second processed voltages fall outside of the first and second upper/lower limit determination thresholds, respectively, or when the first and second processed voltages are not continuous over a predetermined period although the first and second processed voltages fall within the first and second upper/lower limit determination thresholds, the first and second reset determination signals to be output to the NAND circuits 365 and 366 are set to the Lo level. When the processed voltages are continuous over the predetermined period within the range of the upper/lower limit determination thresholds, the first and second reset determination signals are set to the Hi level. The first and second upper/lower limit determination thresholds are determined to be voltages slightly lower than a Hi-level voltage, and the first and second lower limit determination thresholds are determined to be voltages slightly higher than a Lo-level voltage. Switching of the first and second reset determination signals from the Lo level to the Hi level means that the first and second reset request signals match (are considered to match) the reference first and second reset request signals.

When the first and second power supply signals from the first and second microcomputer reset control units 153 and 154 and the first and second reset determination signals from the comparison determination units 363 and 364 are at the Hi level, the NAND circuits 365 and 366 set the first and second reset instruction signals to be output to the first and second microcomputers 30 and 40 to the Lo level, respectively. In the other cases, the first and second reset instruction signals are set to the Hi level. When the first and second reset instruction signals are at the Lo level, the first and second microcomputers 30 and 40 are reset.

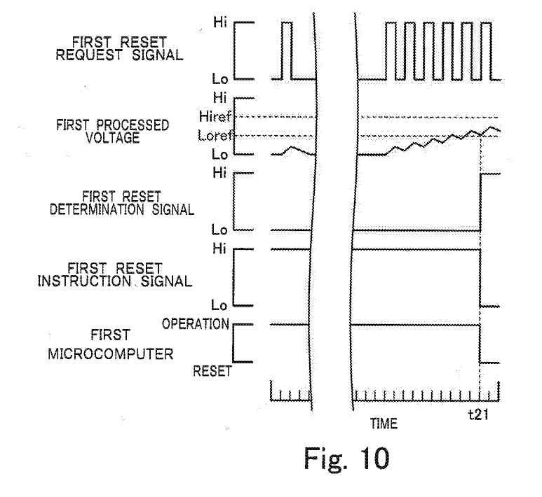

FIG. 10 is an explanatory diagram illustrating an example of an operation of the monitoring system 320 when the first microcomputer monitoring unit 42 of the second microcomputer 40 detects that the first microcomputer 30 is in the abnormal state. When the first microcomputer monitoring unit 42 of the second microcomputer 40 detects the abnormal state of the first microcomputer 30, the first microcomputer reset requesting unit 44 starts to output the first reset request signal that matches the reference first reset request signal. When the processed voltages are continuous over the predetermined period within the upper/lower limit determination thresholds (time t21), the comparison determination unit 363 switches the first reset determination signal from the Lo level to the Hi level. As a result, the first reset instruction signal from the NAND circuit 365 is switched to the Lo level, and the first microcomputer 30 is reset.

Like in the configuration of the monitoring system 20 according to the embodiment, also in the configuration of the monitoring system 320 as described above, when one of the first and second microcomputers 30 and 40 is in the abnormal state, the counterpart control device can be prevented from being erroneously reset due to the abnormality. The gradual change processing units 361 and 362, the comparison determination units 363 and 364, and the NAND circuits 365 and 366 may be implemented by hardware using a general-purpose IC, or similar functions may be implemented by software using a microcomputer or the like.

The monitoring system 20 according to the embodiment is configured as a monitoring system for mutually monitoring the first and second microcomputers 30 and 40 that drive and control the first and second motors 10 and 11, respectively, but instead may be configured as a monitoring system for mutually monitoring two control devices (microcomputers) that drive and control devices other than motors. The monitoring system 20 according to the embodiment is mounted on an electric vehicle or a hybrid vehicle, but instead may be mounted on vehicles other than an electric vehicle and a hybrid vehicle, and mobile bodies such as a ship and an aircraft, or may be mounted on immobile equipment such as construction equipment.

In the monitoring system of the above aspect, the reference reset request signal may be a signal having a predetermined pulse train. In this case, the predetermined pulse train may be a pulse train including a first predetermined number of pulses, a predetermined period, and a second predetermined number of pulses in this order. With the configurations as described above, when one of the first and second control devices is in the abnormal state, the reset request signal for the counterpart control device to be output to the monitoring reset unit from the one of the first and second control devices can be prevented from matching the reference reset request signal.

In the monitoring system according to the present disclosure using a signal having a predetermined pulse train as the reference reset request signal, the monitoring reset unit may include a count unit that counts the number of pulses of the reset request signal as a count value, and a reset instruction unit that resets the counterpart control device assuming that the reset request signal matches the reference reset request signal when the count value is equal to or greater than a predetermined value. With this configuration, when the count unit and the reset instruction unit assume that the reset request signal matches the reference reset request signal, the counterpart control device can be reset. In this case, the monitoring reset unit may further include a cycle monitoring unit that monitors a pulse cycle of the reset request signal, and the count unit may determine, based on the monitoring result obtained by the cycle monitoring unit, whether or not to count the number of pulses of the reset request signal as the count value.

In the monitoring system according to the present disclosure using a signal having a predetermined pulse train as the reference reset request signal, the reset signal is a voltage signal having a Lo level or a Hi level, and the monitoring reset unit may include a gradual change processing unit configured to perform gradual change processing on the reset request signal to generate a processed voltage, and a reset instruction unit configured to reset the counterpart control device, assuming that the reset request signal matches the reference reset request signal when the processed voltage is continuous over a predetermined period within a range of an upper/lower limit determination threshold. With this configuration, when the gradual change processing unit and the reset instruction unit assume that the reset request signal matches the reference reset request signal, the counterpart control device can be reset.

The following describes the correspondence relationship between the primary components of the embodiment and the primary components of the disclosure described in Summary. The first microcomputer 30 of the embodiment corresponds to the “first control device”; the second microcomputer 40 corresponds to the “second control device”; and the monitoring microcomputer 50 corresponds to the “monitoring reset unit”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The disclosure is applicable to, for example, the manufacturing industries of monitoring systems.

1. A monitoring system for mutually monitoring first and second control devices, the monitoring system comprising:
a monitoring reset unit configured to monitor the first and second control devices and reset the first and second control devices, wherein
when the first and second control devices detect an abnormality in a counterpart control device, the first and second control devices output, to the monitoring reset unit, a reset request signal that matches a reference reset request signal for the counterpart control device, respectively, and
the monitoring reset unit resets the counterpart control device when the reset request signal for the counterpart control device from the first and second control devices matches the reference reset request signal.

2. The monitoring system according to claim 1, wherein the reference reset request signal is a signal having a predetermined pulse train.

3. The monitoring system according to claim 2, wherein the predetermined pulse train is a pulse train including a first predetermined number of pulses, a predetermined period, and a second predetermined number of pulses in this order.

4. The monitoring system according to claim 2, wherein the monitoring reset unit includes:
a count unit configured to count the number of pulses of the reset request signal as a count value; and
a reset instruction unit configured to reset the counterpart control device, assuming that the reset request signal matches the reference reset request signal when the count value is equal to or greater than a predetermined value.

5. The monitoring system according to claim 3, wherein the monitoring reset unit includes:
a count unit configured to count the number of pulses of the reset request signal as a count value; and
a reset instruction unit configured to reset the counterpart control device, assuming that the reset request signal matches the reference reset request signal when the count value is equal to or greater than a predetermined value.

6. The monitoring system according to claim 2, wherein
the reset signal is a voltage signal having a Lo level or a Hi level, and
the monitoring reset unit includes:
a gradual change processing unit configured to perform gradual change processing on the reset request signal to generate a processed voltage; and
a reset instruction unit configured to reset the counterpart control device, assuming that the reset request signal matches the reference reset request signal when the processed voltage is continuous over a predetermined period within a range of an upper/lower limit determination threshold.

7. The monitoring system according to claim 3, wherein
the reset signal is a voltage signal having a Lo level or a Hi level, and
the monitoring reset unit includes:
a gradual change processing unit configured to perform gradual change processing on the reset request signal to generate a processed voltage; and
a reset instruction unit configured to reset the counterpart control device, assuming that the reset request signal matches the reference reset request signal when the processed voltage is continuous over a predetermined period within a range of an upper/lower limit determination threshold.
